(19) United States
(12) Patent Application Publication
(10) Pub. No.: US 2019/0257770 A1
(43) Pub. Date: Aug. 22, 2019

(54) MICROWAVE SENSOR

(71) Applicant: Heriot-Watt University, Edinburgh Central Scotland (GB)

(72) Inventors: Marc Philippe Yves Desmulliez, Edinburgh Central Scotland (GB); David Flynn, Edinburgh Central Scotland (GB); David Herd, Edinburgh Central Scotland (GB); Sumanth Kumar Pavuluri, Edinburgh Central Scotland (GB)

(21) Appl. No.: 16/346,106

(22) PCT Filed: Oct. 31, 2017
(86) PCT No.: PCT/GB2017/053277

§ 371 Date: Apr. 29, 2019

(30) Foreign Application Priority Data
Oct. 31, 2016 (GB) 1618378.2

(51) Int. Cl. G01N 22/02

(52) U.S. Cl. CPC G01N 22/02

(57) ABSTRACT

A corrosion sensor (1), adapted to determine the presence of corrosion in a material having at least one layer of a coating material on a surface thereof, is disclosed. The corrosion sensor (1) comprises a microwave transceiver (2); and a waveguide (3), with the waveguide (3) being operably coupled to the microwave transceiver (2). The microwave transceiver (2) transmits a first continuous wave microwave signal incident on the at least one layer and receives a second continuous wave microwave signal reflected from the at least one layer. The first and second continuous wave signals are combined into an intermediate continuous wave microwave signal having a phase difference indicative of corrosion in the material. Both the first and second continuous wave microwave signals are frequency modulated continuous wave signals. A method of sensing corrosion, a system for sensing corrosion and the use of a microwave transceiver to sense corrosion are also disclosed.

The present invention relates to a microwave sensor adapted to determine the presence of anomalies, typically corrosion in an asset having at least one layer of a coating material on a surface thereof.

Corrosion monitoring is required in a wide range of industries, from microelectronics to oil and gas pipelines. Typically the material that is susceptible to corrosion has a layer of an insulating material on the exposed surface, making it difficult to assess the level of corrosion by eye. Traditional methods of monitoring have involved a level of destructive testing, for example, sand-blasting to remove the layers of insulating material to enable visual inspection of the corroded material. To carry out such destructive testing requires a certain amount of downtime for the asset in which the area of inspection lies, and therefore the testing is a commercially unattractive monitoring option. An improvement on destructive testing is to use so-called non-destructive testing, where light, radiation or sound are used to inspect the corrosion underneath the layers of insulating material in situ. Examples of this include using ultrasound, white light interferometry, X-Ray analysis and microwave analysis.

One particular use for non-destructive testing using microwave analysis is in the oil and gas industry as a corrosion sensor, to determine whether there is any anomaly present in pipelines. Pipelines are used to transport oil, gas or a mixture thereof (such as transmix) around and from oil and gas fields. Typically such pipelines have a multilayer structure, with a core formed from a tube having a diameter in the range 0.1 m-1.2 m and an outer cladding or insulating layer. For example, a common construction is to use a steel tube and a polymer based cladding. However, the steel tube is prone to corrosion and therefore other anomalies such as pitting, delamination, metal loss and water ingress, yet this is hidden from view by the polymer insulating layer. Microwave wavelengths are particularly suited to inspect such pipelines, as they give a clear indication of a defect even when hidden within the pipeline structure or between the core and cladding layer. When anomaly detection is carried out using microwave analysis, often a vector network analyser (VNA) is used to both generate and analyse the microwave signal. The VNA is a relatively costly and bulky piece of equipment, and so not suitable where a portable testing method is required. In addition to the cost and relative inconvenience of using a VNA, significant user training is required to be able to utilise the VNA and therefore the microwave analysis method to its full potential.

One option to improve on this situation and provide an anomaly sensor that is at least moveable with respect to the sample of interest is disclosed in U.S. Pat. No. 6,940,295. Rather than using a large, fixed sensor based on a VNA, a fixed translation device on which a microwave sensor is mounted by means of a support assembly is provided. The translation device is then able to move the microwave sensor along an object of interest, and if a second translation device positioned perpendicular to the first is used, the microwave sensor can scan across an entire surface. Any defects present in the material of interest are found by measuring the energy difference between incident and reflected microwave signals. WO2008/051953 also discloses a sensor mounted on a translation device, such that the sensor can be moved across the surface of a material of interest at a fixed scanning distance. Two incident microwave signals are provided, having orthogonal polarisations. Defects in the material of interest are detected by comparing the incident and reflected polarised microwave signals to determine a phase difference. Although such sensors are non-contact devices, and therefore non-destructive, both require the material of interest to be positioned relative to the translation devices, and are therefore not truly portable.

Devices offering greater flexibility by not being mounted on a fixed translation device are disclosed in U.S. Pat. Nos. 6,674,292. 6,674,292 discloses a hand-held microwave non-destructive testing device provided with rollers to contact the surface of the material of interest and provide a fixed scanning distance for the microwave sensor. Defects in a material of interest are detected by analysing the energy difference between incident and reflected microwave signals. Again the scanning distance is fixed, in this case by providing rollers on the housing carrying the microwave sensor, such that whilst the microwave sensor is non-destructive, it is not non-contact.

It is therefore desirable to find a way to provide simple, portable, non-contact and non-destructive testing of the presence of anomalies such as delamination, water ingress and corrosion within a structure formed from a material having a least one layer of a coating material on a surface thereof.

The present invention aims to address these issues by providing, in a first aspect, a microwave sensor, adapted to determine the presence of anomalies in an asset formed from a material having at least one layer of a coating material on a surface thereof comprising a microwave transceiver; and a waveguide; the waveguide being operably coupled to the microwave transceiver, wherein the microwave transceiver transmits a first continuous wave microwave signal incident on the at least one layer and receives a second continuous wave microwave signal reflected from the at least one layer, wherein the first and second continuous wave signals are combined into an intermediate continuous wave microwave signal having a phase difference indicative of an anomaly in the material, and wherein the first and second continuous wave microwave signals are frequency modulated continuous wave signals.

By using a frequency modulated continuous wave microwave signal to create a phase difference indicative of the anomaly in a material, a simple, portable, non-contact and non-destructive testing of the presence of corrosion within a structure formed from a material having a least one layer of a coating material on a surface thereof can be provided.

Preferably, the waveguide is sized and configured to provide a measurable area and resolution of the first and second continuous wave microwave signals.

The waveguide may be cone shaped. Preferably, the cone is a square-based cone.

The sensor may further comprise an alignment module. Preferably, the alignment module is a laser alignment module.

The sensor may be adapted to fit within a hand-held unit.

The sensor may be operable in a near-field mode. Alternatively, the sensor may be operable in a far-field mode.

Preferably, the microwave transceiver generates a broadband microwave spectrum.

The at least one layer of a coating material may be an insulating material.

The coating layer may have a first surface and a second surface, opposite one another, the substrate has a first surface and a second surface, opposite one another, and the material system has an interface between the coating layer and the substrate, such that the anomalies are at a surface of the coating layer, a surface of the substrate and the interface between the coating layer and the substrate, or within the coating layer or the substrate.

The anomalies may comprise delamination, water ingress, corrosion, a material defect, a local variation in chemical composition, a liquid or a gas.

In a second aspect, the present invention provides a use of a frequency modulated continuous wave microwave transceiver operably coupled to a waveguide to determine the presence of an anomaly in an asset formed from a material having at least one layer of a coating material on a surface thereof.

In a third aspect, the present invention provides a method of determining the presence of anomalies in an asset formed from a material having at least one layer of a coating material on a surface thereof, comprising transmitting a first continuous wave microwave signal to be incident on the at least one layer of a coating material; receiving a second continuous wave microwave signal reflected from the at least one layer of a coating material; combining the first continuous wave microwave signal and the second continuous wave microwave signal into an intermediate continuous wave microwave signal having a phase difference indicative of an anomaly in the material; wherein the first continuous wave microwave signal and the second continuous wave microwave signal are frequency modulated continuous wave signals.

The material may have two or more layers of a coating material on a surface thereof.

Preferably, the material is a metal. In this case, the at least one layer of a coating material may be an insulating material.

Preferably, the material forms part of a pipeline.

The method may further comprise transmitting the first continuous wave microwave signal in a near-field mode. Alternatively, the method may further comprise transmitting the first continuous wave microwave signal in a far-field mode.

Preferably, the first continuous wave microwave signal forms part of a broadband microwave spectrum.

In a fourth aspect, the present invention provides a system for determining the presence of anomalies in a material system of an asset comprising a substrate having at least one coating on a surface thereof; comprising a microwave transceiver and a waveguide, the waveguide being operably coupled to the transceiver, the transceiver adapted to transmit a first continuous wave microwave signal and receive a second continuous wave microwave signal; a controller adapted to control the transmission and reception of the first and second continuous wave microwave signals; a processor adapted to combine the first and second continuous wave microwave signals to produce an intermediate continuous wave microwave signal having a phase difference indicative of the presence of anomalies; and a display adapted to display the intermediate continuous wave microwave signal; wherein the first and second continuous wave microwave signals are frequency modulated continuous wave signals.

Preferably, the waveguide is sized and configured to provide a measurable area and resolution of the first and second continuous wave microwave signals.

The waveguide may be cone shaped. In this situation, preferably the cone is a square-based cone.

The system may further comprise an alignment module. Preferably, the alignment module is a laser alignment module.

The microwave transceiver, the waveguide and the control board may be adapted to fit within a hand-held unit.

The sensor may be operable in a near-field mode, such that a sample of material having at least one coating on a surface thereof is placed within the waveguide. Alternatively the sensor may be operable in a far-field mode, such that a sample of material having at least one coating on a surface thereof is placed outside the waveguide.

Preferably the microwave transceiver generates a broadband microwave spectrum.

The present invention will now be described by way of example only, and with reference to the accompanying drawings, in which:

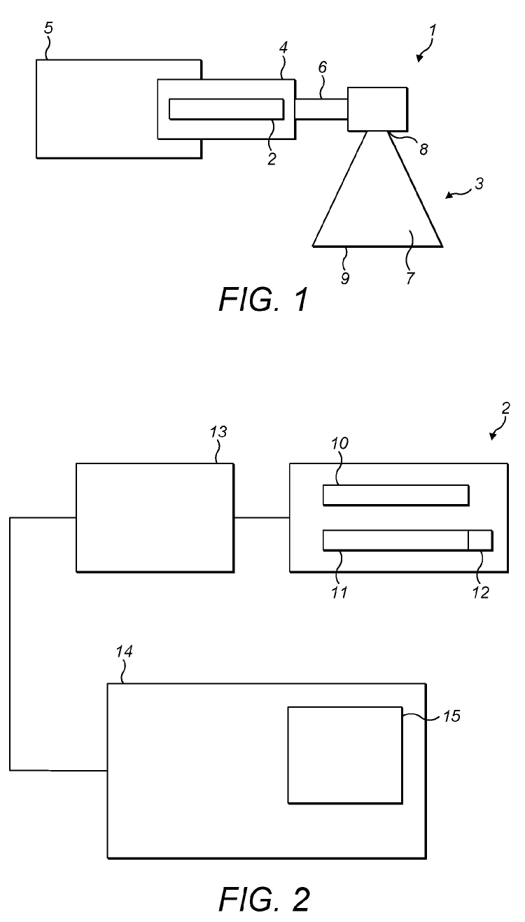

FIG. 1 is a schematic representation of a corrosion sensor in accordance with an embodiment of the present invention;

FIG. 2 is a block diagram of the transceiver indicating its functionality;

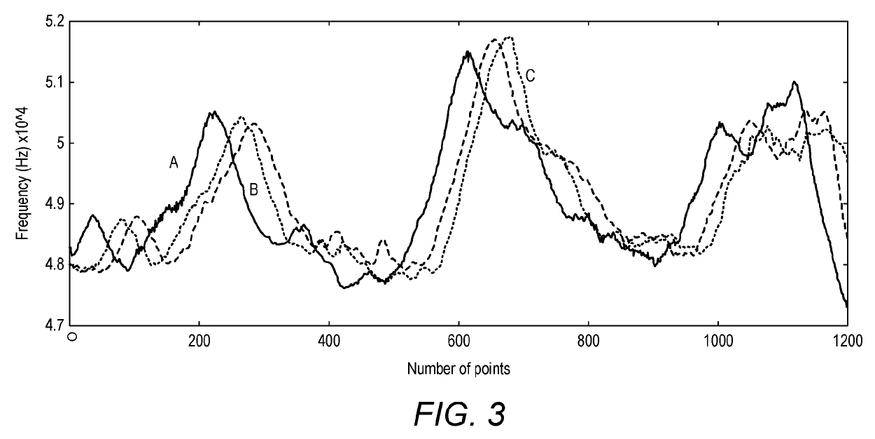

FIG. 3 is a chart showing a sensor trace of frequency against time for three defects in the surface of a copper sheet with no insulating layer applied;

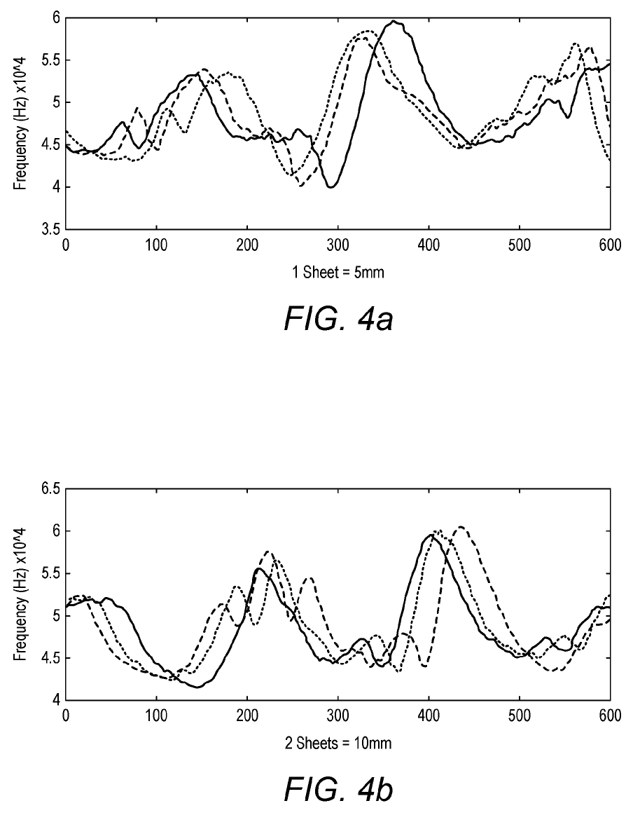

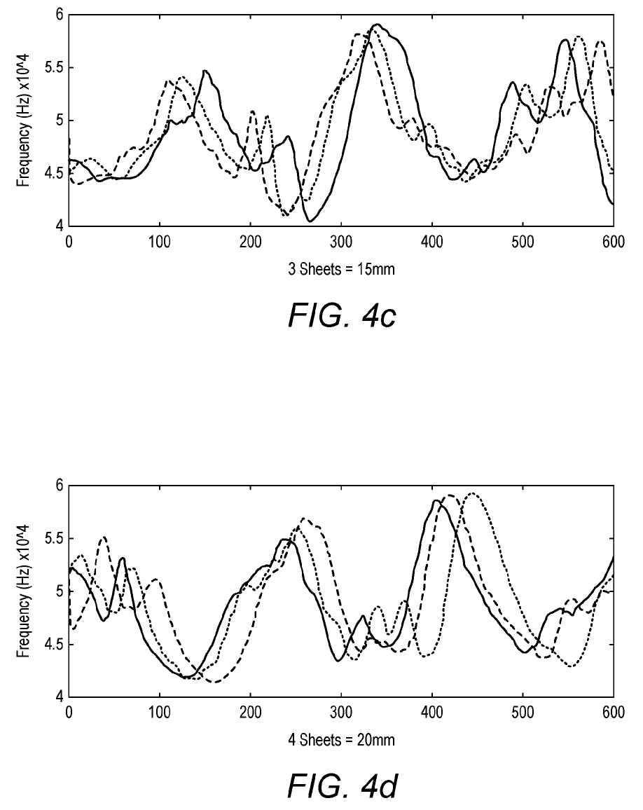

FIG. 4a is a chart showing a sensor trace of frequency against time for three defects in the surface of a copper sheet with a single layer insulating layer applied;

FIG. 4b is a chart showing a sensor trace of frequency against time for three defects in the surface of a copper sheet with two layers of insulating layer applied;

FIG. 4c is a chart showing a sensor trace of frequency against time for three defects in the surface of a copper sheet with three layers of insulating layer applied;

FIG. 4d is a chart showing a sensor trace of frequency against time for three defects in the surface of a copper sheet with four layers of insulating layer applied;

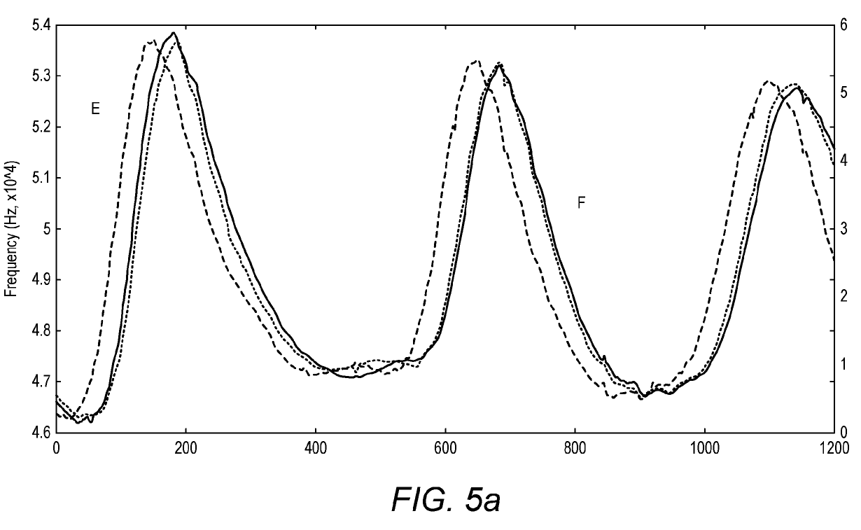

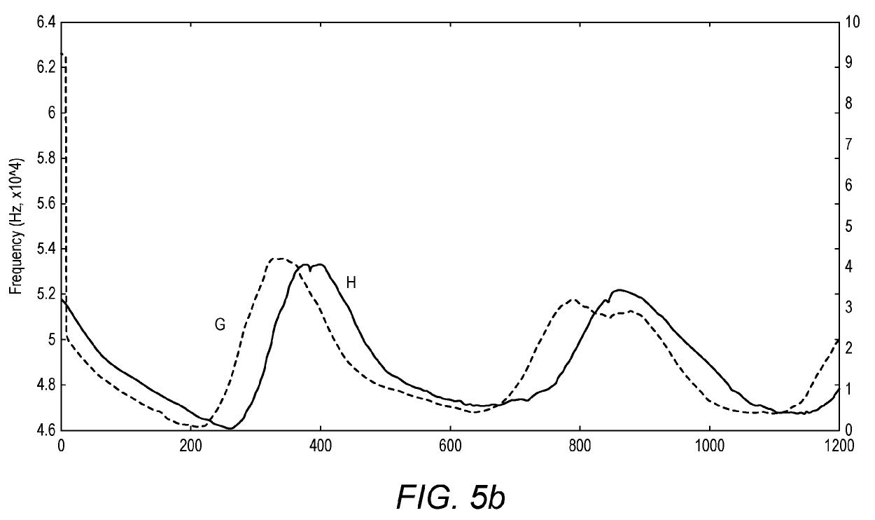

FIG. 5a is a chart showing a sensor trace of frequency against time for a baseline (non-corroded) sample and a first corroded sample;

FIG. 5b is a chart showing a sensor trace of frequency against time for a baseline (non-corroded) sample and a second corroded sample;

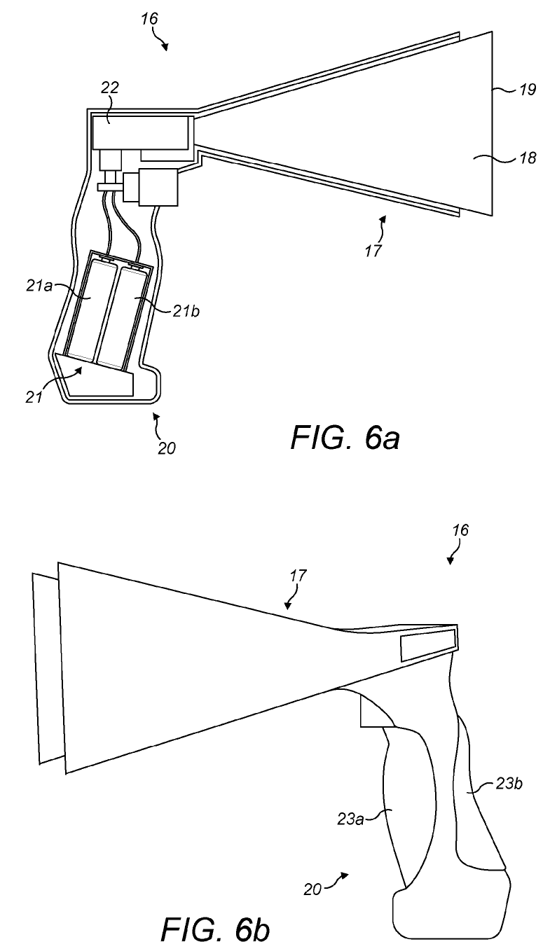

FIG. 6a is a schematic side view of a hand-held corrosion sensor in accordance with an embodiment of the present invention;

FIG. 6b is a schematic cut-away side view of a hand-held corrosion sensor in accordance with an embodiment of the present invention; and

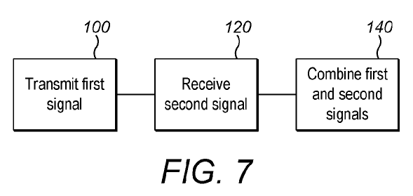

FIG. 7 is a flowchart showing a method of determining the presence of corrosion in a material having at least one layer of a coating material on a surface thereof in accordance with an embodiment of the present invention.

The present invention adopts the approach of creating a microwave sensor, adapted to determine the presence of anomalies an asset comprising a material having at least one layer of a coating material on a surface thereof based on a frequency modulated continuous wave microwave signal. Such a sensor comprises a microwave transceiver and waveguide. The waveguide is operably coupled to the microwave transceiver, and the microwave transceiver transmits a first frequency modulated continuous wave microwave signal. This signal is incident on the at least one layer, and the transceiver receives a second frequency modulated continuous wave microwave signal reflected from the at least one layer. The first and second frequency modulated continuous wave signals are combined into an intermediate modulated continuous wave signal, having a phase difference from which the presence of corrosion is determined. The anomalies may comprise delamination, water ingress, corrosion, a material defect, a local variation in chemical composition, a liquid or a gas This approach differs from those of the prior art in the use of a frequency modulated signal to determine the presence of anomalies rather than the energy of the reflected microwaves or a phase difference between orthogonally polarised microwave signals. As is discussed in more detail below the integration of frequency modulated continuous wave microwave capability into a simple, portable device enables defect testing to be carried out in environments and within timescales not currently achievable.

FIG. 1 is a schematic representation of a microwave sensor in accordance with an embodiment of the present invention. An asset is formed from a material of interest, which comprises a material having at least one layer of a coating material on a surface thereof. The microwave sensor 1 comprises a microwave transceiver 2 and a waveguide 3. The transceiver 2 is mounted on a control board 4, which in turn is mounted on a support 5. The waveguide 3 is operably coupled to the transceiver 2 by means of a coupling section 6, and acts as a resonator for the first frequency modulated continuous wave microwave signal since the interior of the waveguide 3 is a resonant cavity. In this embodiment the waveguide 3 is in the form of a square-based cone 7, with the apex end 8 of the cone being coupled to the transceiver and the base end 9 being open so as to either receive a sample of a material of interest or to be placed in close proximity to a material of interest. The waveguide 3 is formed from a dielectric material. The transceiver 2 transmits a first frequency modulated continuous wave microwave signal that will be incident on a material of interest and receives a second frequency modulated continuous wave microwave signal that is reflected from the material of interest. The first and second continuous wave signals are combined to form an intermediate continuous wave microwave signal having a phase difference indicative of corrosion in the material. The first and second continuous wave microwave signals are frequency modulated continuous wave signals.

The waveguide 3 is sized and configured to provide a measurable area and resolution of the first and second frequency modulated continuous wave microwave signals. A cone-shaped waveguide is particularly suitable for use in the present invention, with a square-based cone being particularly preferred. However, any shape of waveguide that enables the generation and amplification of the standing wave required for the invention to function may be used. The term continuous wave microwave signal is used to distinguish a wave that is transmitted continuously from a microwave source from a traditional pulsed microwave signal, as used, for example, in radar.

The function of the transceiver 2 is shown in more detail in FIG. 2. FIG. 2 is a block diagram of the transceiver indicating its functionality. The transceiver 2 differs from conventional pulsed microwave generation (such as in radar) in that an electromagnetic signal is transmitted and received continuously, generating the first and second frequency modulated continuous wave microwave signal. The transceiver 2 generates a broadband microwave spectrum. The frequency of the first frequency modulated continuous wave microwave signal changes over time in a sweep across a set bandwidth. The difference in frequency between the first frequency modulated continuous wave microwave signal and the second frequency modulated continuous wave microwave signal is determined by mixing the two signals, producing a in intermediate modulated continuous wave microwave signal that can be interrogated to determine the presence of corrosion in a material having at least one layer of coating material on a surface thereof.

A simple and frequently used function to represent the time evolution of the frequency of the first frequency modulated continuous wave microwave signal is a sawtooth function. The second frequency modulated continuous wave microwave signal will be subject to a time delay when compared with the first frequency modulated continuous wave microwave signal due to the time of flight between the microwave sensor and the material of interest. This causes a frequency difference that can be detected as a signal in a low frequency range.

In the present invention, the material of interest is immobile, with the first frequency modulated continuous wave slowed down as it penetrates into the layer of coating material on the surface of the material of interest. Once the first frequency modulated continuous wave microwave signal is generated and fed to the waveguide 3, the waveguide 3 acts as a resonator and a standing wave is set up within the cavity formed by the waveguide 3. The second frequency modulated continuous wave microwave signal is formed from the signal reflected from the materials forming the material of interest and the coating layer on a surface thereof. The first frequency modulated continuous microwave signal is incident on the layer of coating material, slowed down by this layer and then reflected by the material underneath. In typical applications the coating layer is a layer of an insulating material, such as dielectric material, and the material of interest is metallic, either an alloy or a pure metal.

FIG. 2 is a schematic block diagram showing the microwave transceiver 2 and its integration into a larger system. The system determines the presence of corrosion in a material having at least one layer of a coating material on a surface thereof. The transceiver 2 comprises a transmitter 10 and a receiver 11, each of which is coupled to the waveguide 3. In addition, a detector 12 is connected to the receiver 11, to enable the detection of the second frequency modulated continuous microwave signal. A controller 13 is connected to the transmitter 10, the receiver 11, and the detector 12, and configured to control each of these during use. The controller 13 outputs an intermediate modulated continuous wave signal, which is routed to an analogue to digital converter (ADC). A single processing algorithm is applied at a computer 14, having a display 15 for displaying the intermediate modulated continuous wave signal, a phase difference and other various features determined by a user, as well as graphical user interface (GUI) is provided at the computer 14.

In many applications there are relatively high demands on the accuracy of the resonant frequency shift, Q factor shift and change of values of the dielectric permittivity. The frequency of the first frequency modulated continuous microwave signal is swept over a frequency range (sometimes referred to as a sweep range) in discrete frequency steps, while being transmitted continuously. At each frequency the phase difference between the first frequency modulated continuous wave microwave signal and the second frequency modulated continuous wave microwave signal is determined, with the frequency at each step being maintained long enough to allow the second frequency modulated continuous wave microwave signal to return after reflection.

By sweeping the frequency range in a stepwise manner, and detecting, for each frequency, the phase difference between the first frequency modulated continuous wave microwave signal and the second frequency modulated continuous wave microwave signal, it is possible to determine the distance between the waveguide 3 and the surface of the coating material. The distance typically corresponds to several full periods of the first frequency modulated continuous wave microwave signal plus a portion of a period, with the phase difference only providing information about the portion of a period. Therefore a single frequency measurement is not enough to determine the distance between the waveguide 3 and the material of interest. By making several phase difference measurements at different frequencies it is possible to determine the correct number of full periods, and therefore the distance to the material of interest. However, the first frequency modulated continuous wave microwave signal has a certain physical width, resulting in many reflections being received from the material of interest and any other microwave reflectors present. For stepped frequency continuous wave distance measurements, as described above, the phase difference between the transmitted first frequency modulated continuous wave microwave signal and the received second frequency modulated continuous wave microwave signal is determined. The phase detector outputs a value that is related to the cosines of the phase difference. Microwave sensor 1 is placed at a distance D from a sample of a material having a layer of coating material on a surface thereof, such as an insulated pipe (concrete cladding on a steel core). The first frequency modulated continuous wave microwave signal has a frequency in the GHz range, and, swept over a frequency range of 1500 MHz in a stepwise manner from a start frequency of 24 GHz. Each step is 1 MHz. The first frequency modulated continuous wave microwave signal is transmitted into the waveguide 3, and it is reflected by means of the material of interest forming the second frequency modulated continuous wave microwave signal. The frequency of the first frequency modulated continuous wave microwave signal is then incremented one step and the measurement is repeated. This is continued throughout the frequency range of the first frequency modulated continuous wave microwave signal, creating several phase difference values, one for each frequency of the first frequency modulated continuous wave microwave signal. Finally, the distance between the waveguide 3 and the sample is determined by means of the phase difference values. The permittivity or [symbol] factor value determination is based on the bandwidth of the frequency range and the distance between the waveguide 3 and the sample.

The output of the microwave sensor 1 corresponds to the cosine of the phase difference dØ between the first frequency modulated continuous wave microwave signal and the second frequency modulated continuous wave microwave signal, which is given by the reflected phase difference cos(dØ). The phase difference will vary between +1 and −1, corresponding to phase value between 0 and 180°. Typically this difference corresponds to a few full periods of the first frequency modulated continuous wave microwave signal plus a portion of a period.

The transceiver 2 outputs an intermediate modulated continuous wave signal S described by:

S/D=2*BW/(c*T)

where D is the distance between the waveguide 3 and the sample, BW is the bandwith of the first frequency modulated continuous wave microwave signal, c is the speed of light, and T is the time taken for the first frequency modulated continuous wave microwave signal to sweep across the frequency range.

If a sample is placed distance D away from the waveguide 3, then the time difference t between the first and second frequency modulated continuous wave microwave signals is:

t=2D/c

In any practical system, the frequency cannot be continuously changed in one direction; hence only periodicity in the modulation is necessary. Frequency modulation includes triangular waveforms, saw tooth waveforms, sinusoidal waveforms, square waveforms and other suitable waveforms. When a triangular frequency modulated waveform is used, the resulting beat frequency is constant, except for at the turn-around region in the frequency sweep. The first frequency modulated continuous wave microwave signal and the second frequency modulated continuous wave microwave signal are multiplied in a mixer. The high frequency term is filtered out using a low-pass filter a beat frequency f_{b} is obtained. If there is no Doppler shift in the signal, then

f_{b}=tm_{f}=2R/(cm_{f})

where t is the time taken to complete the sweep through the frequency range, R is the distance from the waveguide 3 to the sample, c is the speed of light and m_{f} is the slope of the frequency change of the first frequency modulated continuous wave microwave signal.

But:

m_{f}=Δf/(1/(2fₘ))=2fₘΔf

where fₘ is the modulation rate of frequency and Δf is the maximum deviation of frequency. Therefore:

f_{b}=(4RfₘΔf)c

Usually two beat frequencies exist in frequency modulated continuous wave systems, due to the Doppler effect associated with the penetration of microwave signals into the sample, and scattering effects given by:

f₁=(4RfₘΔf)/c+f_{d}

f₂=(4RfₘΔf)/c−f_{d}

where f_{d} is the frequency associated with the Doppler shift. The first cosine term of the intermediate signal S describes a linearly increasing frequency modulated signal (chirp) at about twice the carrier frequency, with a phase shift that is proportional to the delay time T_{d}. This term is generally filtered out actively by a low pass filter (LPF). The second cosine term describes the beat signal at a fixed frequency, which can be obtained by differentiating the instantaneous phase term with respect to time. The beat frequency is directly proportional to the distance D of the target from the waveguide 3. Therefore, by determining the beat frequency, this distance D can be determined directly. The beat frequency may also be used to determine the dielectric properties of the sample.

In the situation where an anomaly, such as corrosion, occurs on a pipeline, for example, the variation in the beat frequency can be used to determine the regions where corrosion exists, either by determining that there is a localised variation in distance between the metal core of the pipeline and the waveguide 3, of there is a localised change in the dielectric properties of the metal core. As the system is sensitive to changes in distance and material composition this may be achieved through a dielectric material such as the concrete cladding on the metal core of a pipeline. Furthermore a time delay may be seen in the intermediate signal due to the difference in dielectric properties between regions with and without corrosion. The coating layer may have a first surface and a second surface, opposite one another, the substrate has a first surface and a second surface, opposite one another, and the material system has an interface between the coating layer and the substrate. This means that the anomalies are at a surface of the coating layer, a surface of the substrate and the interface between the coating layer and the substrate, or within the coating layer or the substrate.

In order to determine the repeatability of making such measurements, initially a microwave sensor in accordance with an embodiment of the present invention was used to identify defects in the surface of a copper sheet. Initially defects were made in the surface of a copper sheet resulting in a series of circular depressions having equal surface area in the surface of the copper sheet, one of a shallow depth, one of an intermediate depth and one of a deep depth. In order to determine the resolution of the microwave sensor the depth of the depressions was varied, so that the resolution between the shallowest and the deepest depression could be examined.

FIG. 3 is a chart showing a sensor trace of frequency against time for three defects in the surface of a copper sheet with no insulating layer applied. Trace A represents the defect with the shallowest depth, trace B is the defect with the intermediate depth and trace C is the defect with the deepest depth. There is a clear difference in the traces, indicating that not only are the measurements of the sensor repeatable, but that the sensor is able to detect distance accurately.

FIG. 4a is a chart showing a sensor trace of frequency against time for three defects in the surface of a copper sheet with a single layer insulating layer applied. The single layer was approximately 5 mm in thickness and formed from PMMA (poly methyl methacrylate). FIG. 4b is a chart showing a sensor trace of frequency against time for three defects in the surface of a copper sheet with two layers of insulating layer applied. Both layers were approximately 5 mm in thickness and formed from PMMA. FIG. 4c is a chart showing a sensor trace of frequency against time for three defects in the surface of a copper sheet with three layers of insulating layer applied. All three layers were approximately 5 mm in thickness and formed from PMMA. FIG. 4d is a chart showing a sensor trace of frequency against time for three defects in the surface of a copper sheet with four layers of insulating layer applied. All four layers were approximately 5 mm in thickness and formed from PMMA. Comparing the charts indicates that as the layer of insulating material increases in thickness increases the time taken for the sensor to sense the base of the defect. The signature of the traces is similar throughout all of the charts, indicating that the presence of an insulating layer has little effect on the efficacy of the sensor.

Following this initial investigation, further testing was carried out to determine the efficacy of the sensor in determining the present of corrosion. Initial corrosion samples were simulated by etching copper sheets in a bath of ferric chloride solution. FIG. 5a is a chart showing a sensor trace of frequency against time for a baseline (non-corroded) sample and a first corroded sample. Trace D represents the baseline signal, and trace E represents the signal from the corroded sample. There is a clear difference between the positions of the peaks of the two samples over time, but the signal strength is similar for both samples. FIG. 5b is a chart showing a sensor trace of frequency against time for a baseline (non-corroded) sample and a second corroded sample. Trace F represents the baseline signal and trace G represents the signal frequency of the second corroded sample. It can be seen that there is a phase change in the signal response due to the change in conductivity of the sample due to the corrosion, and a significant difference between the traces in terms of time.

Further testing was then done to review the efficacy of the microwave sensor in relation to advanced corrosion. Increasing both the concentration of the ferric chloride etching solution and/or the time the copper sheet remains in the etchant and/or the current applied to the copper sheet during the etching process creates extensive pitting of the surface of the copper sheet. Rust may also form, and there may be some loss of copper underneath the rust. The surface roughness is also increased. Each of these features/artefacts may be detected using a microwave sensor in accordance with an embodiment of the present invention.

The microwave sensor may be operated in a far-field mode. Alternatively, the microwave sensor may be operated in a near-field mode. The near field mode is created when the microwave sensor is excited below a defined cut-off frequency, and the far field mode when excited above the cut-off frequency. The cut-off frequency is defined as the resonant frequency of the waveguide 3.

In the near field mode, a very high Q factor standing wave pattern is required. For example, for near field operation a Q factor more than ten and ideally more than twenty is preferred. When this occurs there is no intrinsic wave impedance match with the surroundings (air). Instead the corrosion sensor is operated below a cut-off frequency when compared to the resonant frequency of the waveguide, for example in TM mode, thereby producing an evanescent wave constituting a near field within the waveguide 3. In this situation a sample is introduced into the waveguide 3

In the far field mode, the field of the excitation wavelength radiates beyond the dielectric reflector surface, as the corrosion sensor is operated above a cut-off frequency. In this case the sample is at a distance that can range between 0.1 mm to 100 cm from the microwave sensor. When the sensor is operated in the far field mode reflected signal parameters, such as the backscattering (diffuse reflection), specular reflection of the first continuous wave microwave signal, the time difference between the first continuous wave microwave signal and the second continuous wave microwave signal and the magnitude of the backscattered or specular reflection of the first continuous wave microwave signal can be measured. Alignment of the microwave sensor may be provided, such as the provision of an alignment module to align the waveguide 3 accurately with a sample. If the microwave sensor further comprises an alignment module, this is preferably a laser alignment module.

FIG. 6a is a schematic side view of a hand-held microwave sensor in accordance with an embodiment of the present invention and FIG. 6b is a schematic cut-away side view of a hand-held microwave sensor in accordance with an embodiment of the present invention. In this embodiment, the microwave sensor is adapted to fit within a hand-held unit. The microwave sensor 16 comprises a housing 17 formed of two main sections: a waveguide portion 18 in the shape of a square-based cone 19 and a handle portion 20. The handle portion 20 houses a power supply 21, which in this example comprises two AA batteries 21a, 21b. A microwave transceiver 22 is positioned within the housing 16 at the junction between the handle portion 20 and the waveguide portion 18 and in electrical connection with the power supply 21. The housing 17 is formed from a plastics material, with the handle portion 20 being shaped to fit within the grasp of a hand, with easy grip portions 23a, 23b provided on opposing sides of the handle portion.

It can be seen from the above examples that a frequency modulated continuous wave microwave transceiver operably coupled to a waveguide can be used to determine the presence of anomalies of a material having at least one layer of a coating material on a surface thereof.

From the above examples it can be seen that a microwave sensor in accordance with the various embodiments of the present invention can be used in a method of anomaly detection. This is outlined in FIG. 7, which is a flowchart showing a method of determining the presence of corrosion in a material having at least one layer of a coating material on a surface thereof in accordance with an embodiment of the present invention. At step 100, a first continuous wave microwave signal is transmitted to be incident on the at least one layer of a coating material. At step 120 a second continuous wave microwave signal reflected from the at least one layer of a coating material is received. At step 140 the first continuous wave microwave signal and the second continuous wave microwave signal are combined to form an intermediate continuous wave microwave signal having a phase difference indicative of corrosion in the material. As above, the first continuous wave microwave signal and the second continuous wave microwave signal are frequency modulated continuous wave signals. The material may have two or more layers of a coating material on a surface thereof. Preferably the material is a metal, in which case the at least one layer of a coating material is an electrical insulator. This combination typically occurs in a pipeline, such as an oil or gas pipeline. As above, the method may involve transmitting the first continuous wave microwave signal in a near-field mode, or in a far-field mode. The first continuous wave microwave signal forms part of a broadband microwave spectrum.

The microwave sensor described above is suitable for use in a number of applications where anomalies in an asset need to be monitored. Anomalies may comprise at least one of a material defect, a local variation in chemical composition, a liquid or a gas. For example, the microwave sensor may be used to detect pitting, delamination, metal loss and water ingress in relation to pipelines in the oil and gas industries, or in other industries such as manufacturing industries where fluids are used or manufactured and where the purity or quality of a material flowing through a pipeline is critical, in the nuclear waste industry, where monitoring of corrosion of storage vessels is a major challenge, in industries where metallic components are manufactured and where surface contamination can affect surface quality and/or component quality. These and other advantages and embodiments will be apparent from the appended claims.

1. A microwave sensor, adapted to determine the presence of anomalies in an asset formed from a material system comprising a substrate having at least one layer of a coating material on a surface thereof comprising:
a microwave transceiver; and
a waveguide;
the waveguide being operably coupled to the microwave transceiver, wherein the microwave transceiver transmits a first continuous wave microwave signal incident on the at least one layer and receives a second continuous wave microwave signal reflected from the at least one layer, wherein the first and second continuous wave signals are combined into an intermediate continuous wave microwave signal having a phase difference indicative of anomalies in the material system, and wherein the first and second continuous wave microwave signals are frequency modulated continuous wave signals.

2. A microwave sensor as claimed in claim 1, wherein the waveguide is sized and configured to provide a measurable area and resolution of the first and second continuous wave microwave signals.

3. A microwave sensor as claimed in claim 1, wherein the waveguide is cone shaped.

4. A microwave sensor as claimed in claim 3, wherein the cone is a square-based cone.

5. A microwave sensor as claimed in claim 1 further comprising an alignment module.

6. A microwave sensor as claimed in claim 5, wherein the alignment module is a laser alignment module.

7. A microwave sensor as claimed in claim 1, wherein the sensor is adapted to fit within a hand-held unit.

8. A microwave sensor as claimed in claim 1, wherein the sensor is operable in a near-field mode.

9. A microwave sensor as claimed in claim 1, wherein the sensor is operable in a far-field mode.

10. A microwave sensor as claimed in claim 1, wherein the microwave transceiver generates a broadband microwave spectrum.

11. A microwave sensor as claimed in claim 1, wherein the at least one layer of a coating material is an insulating material.

12. A microwave sensor as claimed in claim 1, wherein the coating layer has a first surface and a second surface, opposite one another, the substrate has a first surface and a second surface, opposite one another, and the material system has an interface between the coating layer and the substrate, such that the anomalies are at a surface of the coating layer, a surface of the substrate and the interface between the coating layer and the substrate, or within the coating layer or the substrate.

13. A microwave sensor as claimed in claim 1, wherein the anomalies comprise: a material defect, a local variation in chemical composition, a liquid or a gas.

14. Use of a frequency modulated continuous wave microwave transceiver operably coupled to a waveguide to determine the presence of an anomaly in a material system having at least one layer of a coating material on a surface thereof.

15. A method of determining the presence of anomalies in an asset formed from a material system comprising a substrate having at least one layer of a coating material on a surface thereof, comprising:
transmitting a first continuous wave microwave signal to be incident on the at least one layer of a coating material;
receiving a second continuous wave microwave signal reflected from the at least one layer of a coating material;
combining the first continuous wave microwave signal and the second continuous wave microwave signal into an intermediate continuous wave microwave signal having a phase difference indicative of anomalies in the material system; wherein
the first continuous wave microwave signal and the second continuous wave microwave signal are frequency modulated continuous wave signals.

16. A method as claimed in claim 14, wherein the material has two or more layers of a coating material on a surface thereof.

17. A method as claimed in claim 14, wherein the material is a metal.

18. A method as claimed in claim 17, wherein the at least one layer of a coating material is an insulating material.

19. A method as claimed in claim 14, wherein the material forms part of a pipeline.

20. A method as claimed in claim 14, further comprising transmitting the first continuous wave microwave signal in a near-field mode.

21. A method as claimed in claim 14, further comprising transmitting the first continuous wave microwave signal in a far-field mode.

22. A method as claimed in claim 14, wherein the first continuous wave microwave signal forms part of a broadband microwave spectrum.

23. A system for determining the presence of anomalies in a material system of an asset comprising a substrate having at least one coating on a surface thereof; comprising:
a microwave transceiver and a waveguide, the waveguide being operably coupled to the transceiver, the transceiver adapted to transmit a first continuous wave microwave signal and receive a second continuous wave microwave signal;
a controller adapted to control the transmission and reception of the first and second continuous wave microwave signals;
a processor adapted to combine the first and second continuous wave microwave signals to produce an intermediate continuous wave microwave signal having a phase difference indicative of the presence of anomalies; and
a display adapted to display the intermediate continuous wave microwave signal; wherein
the first and second continuous wave microwave signals are frequency modulated continuous wave signals.

24. A system as claimed in claim 23, wherein the waveguide is sized and configured to provide a measurable area and resolution of the first and second continuous wave microwave signals.

25. A system as claimed in claim 23, wherein the waveguide is cone shaped.

26. A system as claimed in claim 25, wherein the cone is a square-based cone.

27. A system as claimed in claim 23, further comprising an alignment module.

28. A system as claimed in claim 27, wherein the alignment module is a laser alignment module.

29. A system as claimed in claim 23, wherein the microwave transceiver, the waveguide and the control board are adapted to fit within a hand-held unit.

30. A system as claimed in claim 23, wherein the sensor is operable in a near-field mode, such that a sample of a material system comprising a substrate having at least one coating on a surface thereof is placed within the waveguide.

31. A system as claimed in claim 23, wherein the sensor is operable in a far-field mode, such that a sample of a material system comprising a substrate having at least one coating on a surface thereof is placed outside the waveguide.

32. A system as claimed in claim 23, wherein the microwave transceiver generates a broadband microwave spectrum.
